(19) United States
(12) Patent Application Publication
(10) Pub. No.: US 2015/0305570 A1
(43) Pub. Date: Oct. 29, 2015

(54) FLIPPER TONG ASSEMBLY

(71) Applicant: KITCHEN INNOVATIONS INC., King City (CA)

(72) Inventors: Michael James Gibson, Atlanta, GA (US); Robert G. Dickie, King City (CA)

(21) Appl. No.: 14/695,791

(22) Filed: Apr. 24, 2015

Related U.S. Application Data
(60) Provisional application No. 61/984,755, filed on Apr. 26, 2014.

(51) Int. Cl. A47J 43/28

(52) U.S. Cl. CPC A47J 43/288; A47J 43/283

(57) ABSTRACT

A kitchen utensil selectively usable as tongs or a spatula. The utensil has first and second arms each with first and second ends. The first ends are pivotally secured together and the arms are moveable between a position where they are adjacent each other and a position where they are at an angle relative to each other. The second arm telescopes and is movable between a retracted position and an extended position. When retracted, the second ends are substantially adjacent and opposite each other. When extended, the second end of the second arm is positioned a distance outwardly beyond the second end of the first arm. The second end of the first arm is a shaped tong member and the second end of the second arm is a spatula member. The tong and spatula members are each positioned at an angle relative to the rest of the respective arm.

### CROSS-REFERENCE TO RELATED APPLICATION

This application claims the benefit of U.S. Provisional Patent Application Ser. No. 61/984,755, filed Apr. 26, 2014, the entire specification of which is incorporated herein by reference.

### BACKGROUND OF THE INVENTION

1. Technical Field

This invention relates generally to kitchen utensils. More particularly, this invention is directed to cooking and food preparation utensils. Specifically, this invention relates to an assembly which includes a tong member arm and a spatula member arm pivotally engaged together at one end; the assembly is selectively movable between a first position where the assembly may be used as tongs and a second position where the assembly may be used as a spatula.

2. Background Information

Tongs are used during all types of cooking activities including adding, removing or turning food when the food is being cooked in a pot or pan or on a grill. Tongs include two opposed members which are pivotally engaged with each other at a first end. The two members are configured as mirror images of each other and each includes a concave spoon-shaped region at a second end remote from the first end. The tong members are positioned so that the concave spoon-shaped regions are directly opposed to each other. The engaged first ends of the tong members typically include a spring mechanism which biases the spoon-shaped ends away from each other. Consequently, the default position of the tongs is an open position. The user will engage the sides of the two tong members and push them toward each other, thereby moving the spoon-shaped regions toward each other so that food substances may be grasped between the spoon-shaped regions. If no food is captured between the tong members then the terminal ends of the spoon-shaped regions will contact each other. Typically, no other region of the spoon-shaped regions will contact each other.

When the user stops pushing the sides of the two tong members together the spring will return to its default position and rotate the spoon-shaped regions away from each other, thereby releasing any food substance captured therebetween. Some pairs of tongs may include a locking mechanism which will hold the tongs in a closed position so that the tongs may be more easily stored.

Large BBQ tongs are known which include spatula type ends instead of the spoon-shaped regions. What is meant by the term “spatula” in relation to these BBQ tongs is a generally flattened or planar surface suitable for sliding under hamburger patties or eggs for example. These generally flattened or planar surfaces may be narrower in width at an end closer to the pivotal connections between the tong members and wider at the terminal end remote from the tong members. Because the spatula region is flattened, the spatula region is generally aligned along the center axis of the implement's handle. This style of BBQ tong has tong members which are generally straight along their length because the edge of a BBQ grill is typically around waist height. There are therefore few to no edges on a grill which could hit the handle of the tongs during use. Consequently, the spatula region is able to be oriented relatively flat to the grill surface, Some BBQ tongs are configured so that one of the tong members includes a spatula-type region and the other of the tong members includes a spoon-shaped region. The spatula-type region and spoon-shaped region are located opposite each other so that food substances, such as hamburger patties, may be captured therebetween.

Spatulas used in stove-top cooking, on the other hand, tend to have handles that are angled relative to the spatula at the end of the handle. This angled configuration is used so that while the spatula is able to slide along and be oriented generally parallel to the flat bottom of a frying pan, for example, the handle is able to clear the upper edge of the side wall of the pan. This configuration allows the spatula to slide under more delicate foodstuffs and ensures that the handle will not contact the edge of the pan when the spatula is in use. Typically, the angle of the handle relative to the spatula is in the range of about 25 degrees off the handle's center axis. For flipping foodstuffs such as eggs, for example, it would be problematic to have any member opposing the spatula as that opposing member would interfere with the spatula being slid under the foodstuff in order to turn or flip the same. Any such opposing member would tend to catch the flipping food or hit the edge of the pan.

### SUMMARY

There remains a need in the art for an improved cooking utensil which may be used to readily and easily grasp and flip or turn foods cooking in pots, pans or on grills.

A kitchen utensil which is selectively usable as tongs or as a spatula is disclosed. The utensil has first and second arms each with first and second ends. The first ends are pivotally secured together and include a spring assembly which enables the arms to be moved between a closed position and an open position. In the closed position the arms are generally adjacent each other along their lengths. In the open position the arms are oriented at an angle relative to each other. The arms are moved to the closed position to grip food substances between their second ends and are moved to the open position to release the food substances.

The second arm of the kitchen utensil is a telescoping arm that is movable between a retracted position and an extended position. When the second arm is in the retracted position, the second ends of the first and second arms are located substantially opposite and laterally adjacent each other. In this configuration, the kitchen utensil is able to be used as tongs. When the second arm is in the extended position, the second end of the second arm is positioned a distance outwardly beyond the second end of the first arm. In this configuration, the kitchen utensil is able to be used as a spatula.

The kitchen utensil's first and second arms are differently shaped. Each arm has a handle portion and the handle portions are substantially identical to each other. The second end of the first arm is a tong member that may be shaped to have an appearance similar to a human hand. This tong member is engaged with the handle portion of the first arm. The second end of the second arm is a spatula member shaped similarly to the flattened region of an egg flipper, and the spatula member is engaged with the handle portion of the second arm. The tong and spatula members may each be positioned at an angle relative to the handle portion of the respective arm. A locking mechanism may be provided to lock the second arm in one or each of the retracted and extended positions so that a user may select to use the kitchen utensil as a pair of tongs to grasp food or as a spatula to flip over food such as eggs or burgers.

In one aspect, the invention may provide a kitchen utensil comprising a first arm having a first end and a second end; a second arm having a first end and a second end; wherein the first ends of the first and second arms are pivotably engaged with each other and the second ends are selectively movable laterally toward each other or away from each other; and wherein the first arm is of a fixed first length measured between the first and second ends thereof and the second arm is of a variable second length measured between the first and second ends thereof.

In another aspect, the invention may provide a kitchen utensil comprising a first arm having a first end and a second end; a second arm having a first end and a second end and a longitudinal axis extending therebetween; wherein the first ends of the arms are pivotally engaged with each other and the arms are movable between a first position where the second ends thereof are located laterally proximate each other and a second position where the second ends are located laterally spaced from each other; and wherein the second arm is a telescoping arm and the second end thereof is selectively extendable along the longitudinal axis thereof.

In another aspect, the invention may provide a method of using a kitchen utensil comprising providing a utensil having a first arm with first and second ends and a second arm with first and second ends, and where the first arm is of a fixed length and the second arm telescopes and is of a variable length; where the first ends of the arms are pivotally engaged so that the arms are selectively movable between a first position where they are adjacent each other along their lengths and a second position where the arms are disposed at an angle relative to each other; and where the second end of the first arm is of a first configuration and the second end of the second arm is of a different second configuration; selecting the length of the second arm so that the second ends of the arms are substantially opposite and laterally adjacent each other to use the utensil as tongs; or selecting the length of the second arm so that the second end of the second arm is located a distance outwardly beyond the second end of the first arm to use the utensil as a spatula.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 is a top perspective view of a flipper tong assembly in accordance with an aspect of the invention shown with a second arm thereof in a retracted position and with the assembly in a locked position;

FIG. 2 is a top perspective view of the flipper tong assembly with the second arm thereof in an extended position and with the assembly in the locked position;

FIG. 3 is a top perspective view of the flipper tong assembly shown in an unlocked position and with the second arm in the retracted position;

FIG. 4 is a bottom perspective view of the flipper tong assembly of FIG. 1;

FIG. 5 is a bottom perspective view of the flipper tong assembly of FIG. 2;

FIG. 6 is a bottom perspective view of the flipper tong assembly of FIG. 3;

FIG. 7 is a right side view of the flipper tong assembly of FIG. 1;

FIG. 8 is a right side view of the flipper tong assembly of FIG. 2;

FIG. 9 is a right side view of the flipper tong assembly of FIG. 3;

FIG. 10 is a bottom view of the flipper tong assembly of FIG. 3;

FIG. 11 is a left side cross-section taken along line 11-11 of FIG. 10;

FIG. 12 is a top view of the flipper tong assembly of FIG. 1;

FIG. 13 is a bottom view of the flipper tong assembly of FIG. 1;

FIG. 14 is a left side cross-section taken along line 14-14 of FIG. 13;

FIG. 15 is a top perspective view of the flipper tong assembly with the first arm removed for clarity and showing the locking member positioned in a first position on the second arm;

FIG. 16 is an enlarged top perspective view of the highlighted region of FIG. 15;

FIG. 17 is an exploded top perspective view of the second arm; and

FIG. 18 is an exploded bottom perspective view of the second arm.

Similar numbers refer to similar parts throughout the drawings.

### DETAILED DESCRIPTION

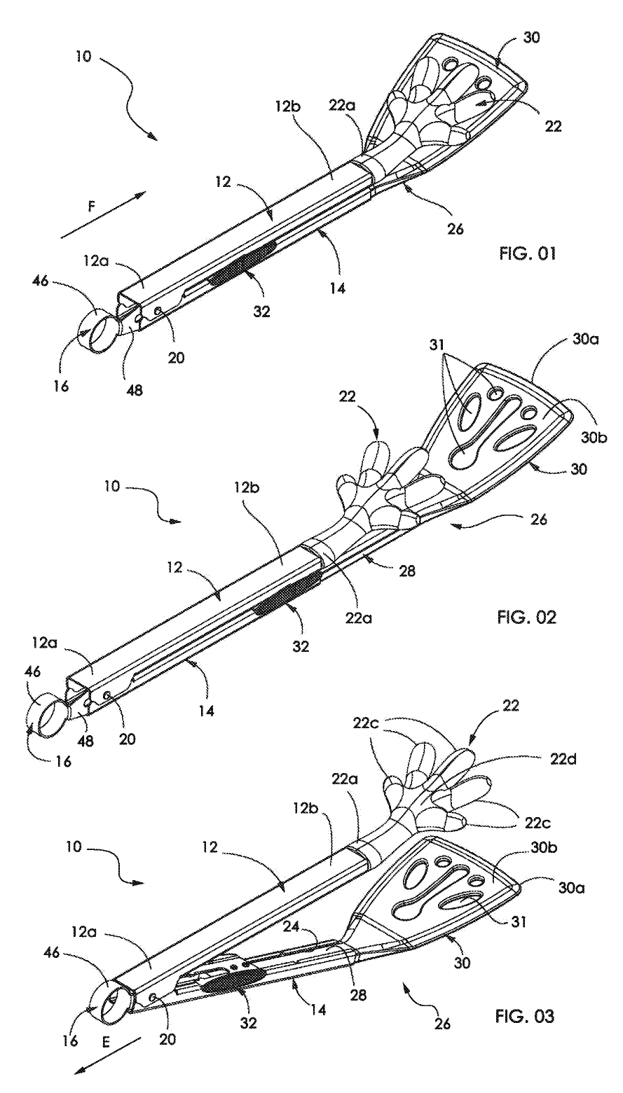

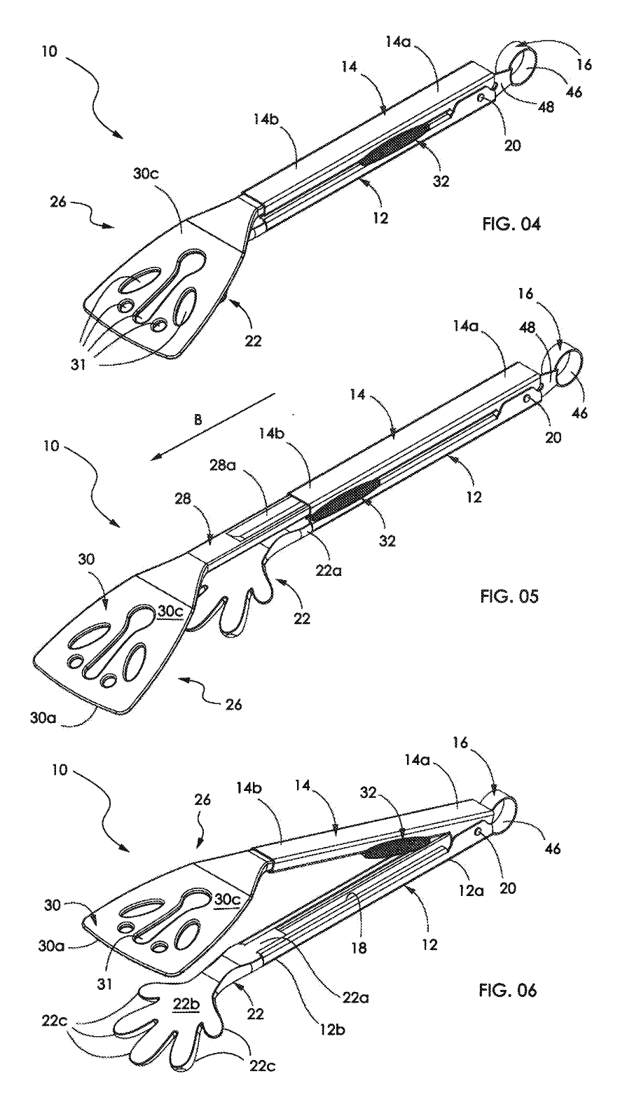

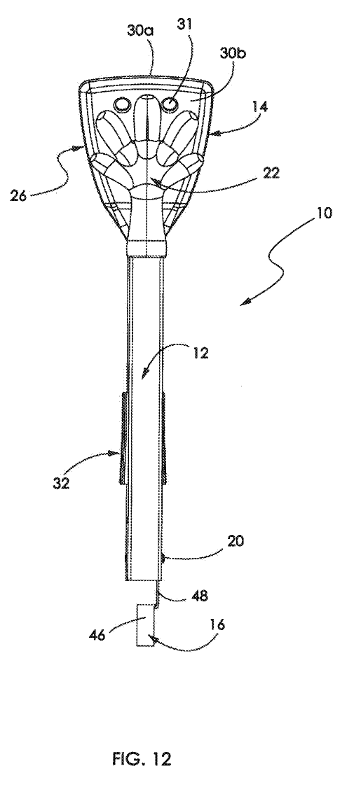

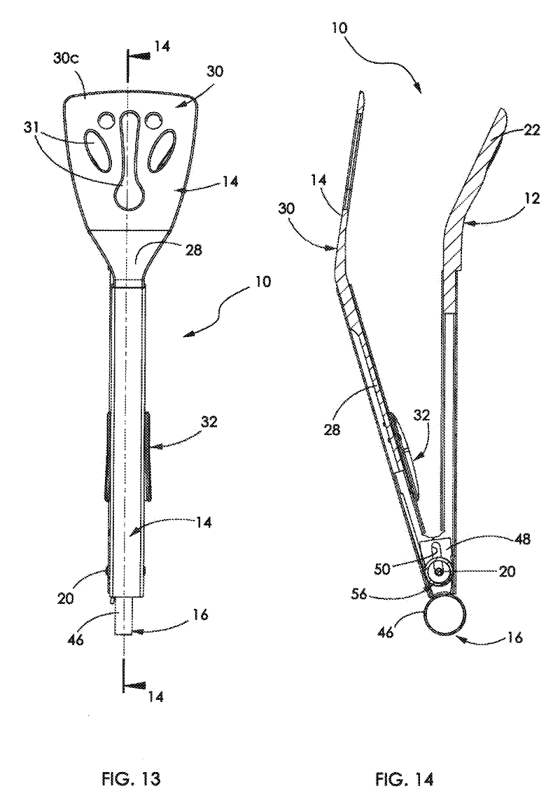

Referring to FIGS. 1-18 there is shown a flipper tong assembly in accordance with an aspect of the present invention, with the assembly being generally indicated at 10. Assembly 10 includes a first arm 12 and a second arm 14 which are opposed to each other and are pivotally joined together at one end by a spring assembly 16. Flipper tong assembly 10 may be fabricated from various materials such as stainless steel, plastic, or silicon; or a combination of the aforementioned materials or any other suitable materials.

First arm 12 includes a handle and a tong member 22. The handle has a first end 12a and a second end 12b and a longitudinal axis “Y1” (FIG. 9) extending between first and second ends 12a, 12b. The handle of first arm 12 is an elongate member that may be generally C-shaped in cross section and defines a channel 18 (FIG. 6) in the arm's interior wall. Channel 18 may extend from first end 12a through to second end 12b. First end 12a defines a hole (not numbered) oriented at right angles to longitudinal axis “Y1” and through which a pivot pin 20 extends to secure first arm 12, second arm 14 and spring assembly 16 together.

Tong member 22 is engaged with second end 12b of the handle of first arm 12. Tong member 22 includes a base 22a (FIG. 6) that is interlockingly received within channel 18 and is secured therein by friction or by some other means such as fasteners or a non-heat sensitive adhesive. Alternatively, tong member 22 may be integrally formed with first arm 12 or may be welded thereto if the first arm 12 is fabricated from metal. Effectively tong member 22 comprises the useful second end of the first arm 12 which forms a food-contacting surface used during cooking.

Tong member 22 may take any one of a variety of configurations. One configuration may be similar to that of a human hand as is particularly seen in FIG. 2. In this configuration, tong member 22 includes a palm region 22b which extends longitudinally outwardly from base 22a, a plurality of digits regions 22c which radiate outwardly from palm region 22b, and a back region 22d (FIG. 3) which is opposed to palm region 22b. It should also be noted from FIG. 9 that palm region 22b may be a planar, flat surface.

As best seen in FIG. 9, base 22a of tong member 22 is aligned with longitudinal axis “Y1” of first arm 12 and the rest of tong member 22 is angled relative to base 22a and to longitudinal axis “Y1” of first arm 12. Since the majority of tong member 22 is set at an angle “A1” of about 25 degrees relative to longitudinal axis “Y1, the tong member 22 will further be described herein as being substantially entirely disposed at the angle “A” relative to longitudinal axis “Y1”. The angle “A1” of tong member 22 relative to the handle of first arm 12 makes it easier for a user to use the member inside a frying pan.

It will be understood that instead of having a “hand-shaped” tong member 22 provided at the second end 12b of the handle of first arm 12, any other differently shaped tong member may be provided thereon. So, for instance, instead of the hand-shaped tong member 22 having a planar and flat palm region 22b, a concave depression may be defined in palm region 12b. Furthermore, instead of hand-shaped tong member 22, a traditional spoon-shaped tong member may be utilized at the second end of the handle of first arm 12. Any other desired configuration for tong member 22 may be provided on second end 12b of the handle of first arm 12. Additionally, while the tong member 22 has been disclosed as being oriented at an angle “A1” of about 25 degrees relative to the longitudinal axis “Y1”, the tong member 22 may be oriented at more than 25 degrees relative to the longitudinal axis “Y1” or less than 25 degrees relative thereto. The angle “A1” may be particularly selected to match a particular anticipated use of flipper tong assembly 10.

First arm 12 is of a fixed length, where the length is measured from first end 12a of the handle thereof to the tip 22c of the longest “finger” on the hand-shaped tong member 22.

As shown in FIG. 6, second arm 14 of assembly 10 has a handle with a first end 14a and a second end 14b and a longitudinal axis “Y2” (FIG. 9) running from first end 14a to second end 14b. The handle of second arm 14 is generally C-shaped in cross-section and the interior surface thereof defines a channel 24 (FIG. 3) therein which runs from first end 14a to second end 14b. First end 14a of the handle of second arm 14 is secured via spring assembly 16 to first end 12a of the handle of first arm 12. Spring assembly 16 will be further described later herein. Spring assembly 16 pivotally engages first and second arms 12, 14 together and makes it possible for the handles thereof to move toward and away from each other. When utensil is moved to a closed position, the handles of first and second arms 12, 14 are disposed adjacent each other and when the utensil is moved to an open position, the handles of first and second arms 12, 14 rotate away from each other and are angled relative to each other and spaced apart.

An extension 26 is engaged with the handle of second arm 14. Extension 26 includes a leg 28 and a spatula member 30 extending outwardly from a first end of leg 28. Second end of leg 28 is receivable in channel 24 of the handle of second arm 14 such that spatula member 30 effectively becoming the useful working second end of second arm 14. As best seen in FIG. 5, leg 28 includes a boss 28a which runs for substantially the entire length of leg 28 and ensures a friction fit of leg 28 within channel 24. Second arm 14 is a telescoping arm that is selectively variable in length. The variability in length is provided by adjusting the position of leg 28 within channel 24. Leg 28 is slidable in channel 24 in either of a first direction, as indicated by arrow “B” (FIG. 5), or a second direction that is opposite to arrow “B”. A stop (not shown) may be provided on second arm to prevent leg 28 from sliding entirely out of channel 24.

When leg 28 is moved in the first direction “B”, the overall length of second arm 14, as measured from first end 14a of the handle thereof to the tip 30a of spatula member 30, increases. When leg 28 is moved in the second direction within the handle of second arm 14, i.e., opposite to “B”, the overall length of second arm 14 decreases. Second arm 14 is therefore selectively movable between a retracted position where spatula member 30 is disposed opposite tong member 22, and an extended position where spatula member 30 is located a distance outwardly beyond tong member 22. In order to use spatula member 30 most effectively during cooking, when second arm 14 is moved to the extended position the spatula member 30 may be located almost entirely beyond tip 22c of the longest “finger” of tong member 22.

Spatula member 30 is a flattened planar member that may be oriented at an angle “A2” (FIG. 9) relative to leg 28 and the handle of second arm 14. Angle “A2” may be about 25 degrees. Thus, the angle “A1” of tong member 22 is substantially the same as the angle “A2” of spatula member 30. This ensures that tong member 22 and spatula member 30 are able to nest together in such a fashion that they will be able to readily grip articles between their interior surfaces 22b and 30b.

If it is desired to differently configure flipper tong assembly 10 so that either of the tong member 22 or spatula member 30 is oriented at an angle other than 25 degrees, then the other of the tong member 22 or spatula member 30 may be fabricated to be similarly oriented so that utensil 10 may be used as an effective gripper.

Spatula member 30 may be narrower proximate leg 28 and flare outwardly therefrom, terminating in an edge 30a that is substantially wider than the width of leg 28. Spatula member 30 has an inner surface 30b and an outer surface 30c. A plurality of apertures 31 may extend between inner and outer surfaces 30b, 30c. As shown in FIG. 1, when extension 26 is in the retracted position, tong member 22 and spatula member 30 are positioned laterally adjacent and opposite each other. Furthermore, the tips of the digit regions 22c may be positioned inwardly of the perimeter of spatula member 30. In particular, the tips of the digit regions 22c may be positioned a distance inwardly away from edge 30a of spatula member 30. It should also be noted that tong member 22 may be from about 20% up to about 35% smaller than spatula member 30.

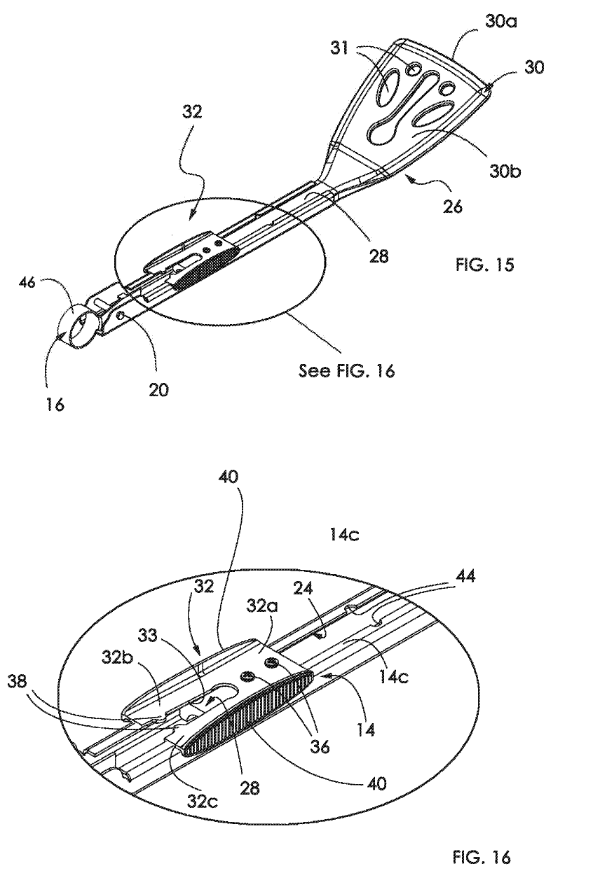

A locking member 32 may be provided to selectively lock extension 26 in the retracted position (FIGS. 1, 3, 4 and 6) or in the extended position (FIGS. 2 and 5). This locking feature is preferred so that there is no slippage of leg 28 within into channel 24 during use the assembly 10. Referring to FIGS. 15-18 it can be seen that the edges 14c of second arm 14 which define channel 24 between them also define one or more pairs of aligned notches therein. In the embodiment shown herein two pairs of aligned notches 42 and 36 are defined in edges 14c. A first aligned pair of notches 42 is defined in edges 14c a short distance from first end 14a; and a second aligned pair of notches 44 is defined in edges 14c a spaced distance from notches 42. Notches 44 are spaced proximate second end 14b of second arm 14.

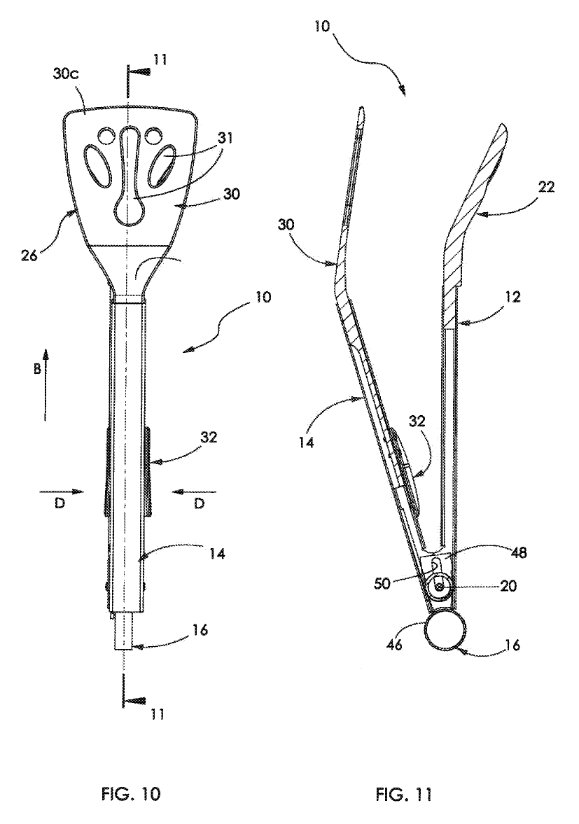

Locking member 32 includes a planar, generally U-shaped member having a base 32a with two opposed legs 32b, 32c extending outwardly therefrom. Legs 32b, 32c define a slot 33 between them. Base 32a is fixedly secured to an end of leg 28 of extension 26 by one or more fasteners 36. A pair of opposed and aligned detents 38 may be provided on legs 32b, 32c. Detents 38 extend into slot 33 and are configured to be selectively engaged within notches 42 or notches 44. Locking member 32 further includes a pair of contact pads 40. Each pad 40 may be provided on one of the side edges of the U-shaped member of locking member 32. Each pad 40 is disposed at right angles to base 32a and legs 32b, 32c and is positioned adjacent the exterior surface of one of the sides of second leg 14 (FIG. 10). Knurling or some other textured surface may be provided on the exterior surface of pads 40 to help a user to grip and manipulate locking member 32. Pads 40 are pushed inwardly toward each other in the direction of arrow “D” (FIG. 10) to disengage detents 38 from the one of the pairs of notches 42 or 36 with which locking member 32 is engaged. Applying such a force on pads 40 causes legs 32b, 32c to deflect inwardly into slot 33 thereby releasing detents 38 from their engagement in the associated notches 42 or 36. Once detents 38 are released from the notches, locking member 32 and the extension 26 secured thereto may be moved in either of the first direction “B” or second direction (opposite to “B”) along channel 24 of second arm 14. So, for example, if locking member 32 is engaged with first pair of notches 42 as in FIG. 10, releasing locking member 32 and sliding locking member 32 and thereby leg 28 in the direction of arrow “B” will cause the portion of leg 28 which extends outwardly from second end 14b of second arm 14 to increase in length. The overall length of second arm 14 is thereby increased. When detents 33 on locking member 32 come into the vicinity of the second pair of notches 44, detents 33 become engaged in notches 44, thereby halting further movement of leg 28 in the direction of arrow “B”. At this point, second arm is in the extended position. When it is desired to move second arm 14 to the retracted position, the user places an index finger on one of the pads 40 and a thumb on the other pad and depresses the pads 40 inwardly in the direction of arrow “D” (FIG. 10). Locking member 32 may then be moved along second arm 14 until detents 33 slide into first pair of notches 42. It is not necessary for the user to continue to apply inward force in the direction of arrow “D” during this sliding motion of locking member 32 along second arm 14 in the direction of arrow “B” or in the opposite direction.

As indicated previously herein, flipper tong assembly 10 may include the spring assembly 16 which holds the first and second arms 12, 14 in a substantially adjacent configuration when in a first position (FIGS. 1 and 2) and allows first and second arms 12, 14 to be disposed at an angle relative to each other when in a second position (FIG. 3). When spring assembly 16 is in a first position, first and second arms 12, 14 are substantially prevented from moving relative to each other and are locked in this adjacent relationship. This first position would therefore be suitable for configuring assembly 10 for storage. When spring assembly 16 is in the second position, then first and second arms 12, 14 can be moved toward and away from each other and the assembly 10 may be used to pick up and release articles, such as meat, for example.

Spring assembly 16 includes a ring member 46 which defines an aperture 46a therein. A user inserts a fingertip through aperture 46a to grasp spring assembly 16 in order to activate or deactivate the same. Spring assembly 16 further includes a flange 48 which extends radially outwardly from the circumference of ring member 46. Flange 48 is located at one edge of ring member 46 and extends in a direction that will be oriented substantially parallel to the longitudinal axis “Y2” of second arm 14 when the various components are engaged with each other to form assembly 10. Flange 48 defines a slot 50 therein that extends between the inner and outer surfaces thereof. Slot 50 is of a width sufficient to receive pin 20 therethrough and the length of slot 50 is substantially greater than the diameter of pin 20. Slot 50 is so oriented that pin 20 will be disposed substantially at right angles to longitudinal axis “Y1” and to longitudinal axis “Y2” when first and second arms 12, 14 are secured together by spring assembly 16. Pin 20 is able to slide back and forth along slot 50 when spring assembly 16 is activated (engaged) or deactivated (disengaged) A detent 52 extends laterally outwardly from a top edge of flange 48.

Spring assembly 16 further includes a spring 56 having a first leg 56a that engages first arm 12 and a second leg 56b that engages second arm 14. When flipper tong assembly 10 is fabricated, flange 48 of spring assembly 16 may be inserted into the entrance 58 to channel 28 defined at first end 14a of second arm 14. Spring 56 is positioned adjacent flange 48 in channel 58 and detent 52 keeps spring 56 in place. First arm 12 is positioned so that first end 12a thereof interlockingly engages first end 14a of second arm 14 and so that holes (not shown) in first end 12a align with holes 54 in first end 14a. Pin 20 is inserted through the aligned holes in first ends 12a, 14a, through slot 50, through the central bore (not numbered) of spring 56, and then through the other aligned holes in first ends 12a, 14a. Pin 20 is locked in position by some suitable means such as by way of a mating pin section. Alternatively, pin 20 may comprise a rivet or other suitable fastener which passes through the various holes and bores and locks the aforementioned components together.

When it is desired to lock first and second arms 12, 14 in the adjacent configuration (such as in FIG. 1), a user will insert a fingertip through ring 46 and pull ring 46 in the direction indicated by arrow “E” (FIG. 3). This motion causes part of flange 48 to be withdrawn through opening 58 and causes legs 56a, 56b of spring 56 to be compressed inwardly toward each other. When it is desired to unlock first and second arms 12, 14 and move them to the position shown in FIG. 3, a user will insert a fingertip through ring 46 and push ring 46 in a direction indicated by arrow “F” (FIG. 1). This motion causes flange 48 to be pushed further into opening 58 and allows spring 56 to move to its at rest position, i.e., legs 56a and 56b are able to move away from each other, thereby urging first and second arms 12, 14 to move to an angled orientation relative to each other. The second position, shown in FIG. 3, is the default position for flipper tong assembly 10.

Flipper tong assembly 10 is used in the following manner. If assembly 10 is in the locked position shown in FIG. 1 and it is desired to use the spatula member 30 as a flipper to turn over food or for any other purpose, locking member 32 is moved from the position shown in FIG. 1 to the position shown in FIG. 2, i.e., in the direction of arrow “B” (FIG. 5). In order to do this, locking member 32 needs to be disengaged. This is accomplished by pushing the sides of locking member 32 inwardly in the direction of arrow “D” (FIG. 10) to disengage detents 38 from notches 44. Once detents 38 have disengaged, locking member 32 may be moved toward second end 12a of the handle of first arm 12 in the direction of arrow “B”. The movement of locking member 32 causes leg 28 to slide a distance out of the channel 24 until locking member 32 reaches notches 42. At this point, spatula member 30 is in the position shown in FIG. 2 and is spaced a distance outwardly beyond the tips of the digits 22c of tong member 22. In this extended position, spatula member 30 may be used without interference from tong member 22 for two reasons. Firstly, tong member 22 terminates a distance inwardly from the innermost end or beginning of spatula member 30. Consequently, substantially the entire surface area of spatula member 30 may be used to flip eggs, for example. Second, first and second arms 12, 14 may be positioned adjacent to each other to make it easier to operate utensil 10 as a flipper. In this position, tong member 22 does not angle away from spatula member 30 and therefore will not accidentally encounter a side wall of a pan, for example, while spatula member 30 is in use. Additionally, the complementary angle of spatula member 30 and tong member 22 makes it possible and easy for the user to use spatula member 30 in a pan, as would be the case with a traditional spatula.

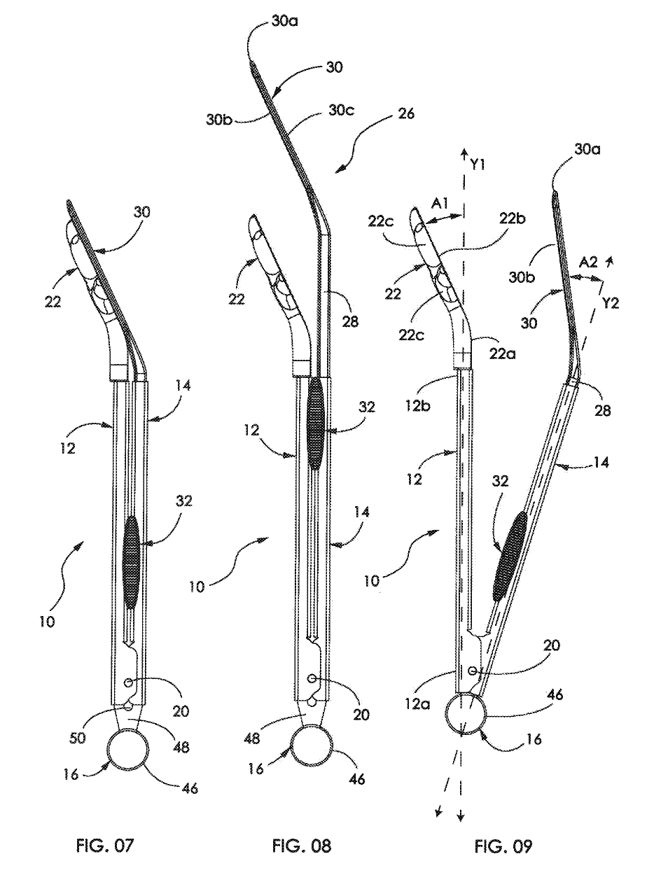

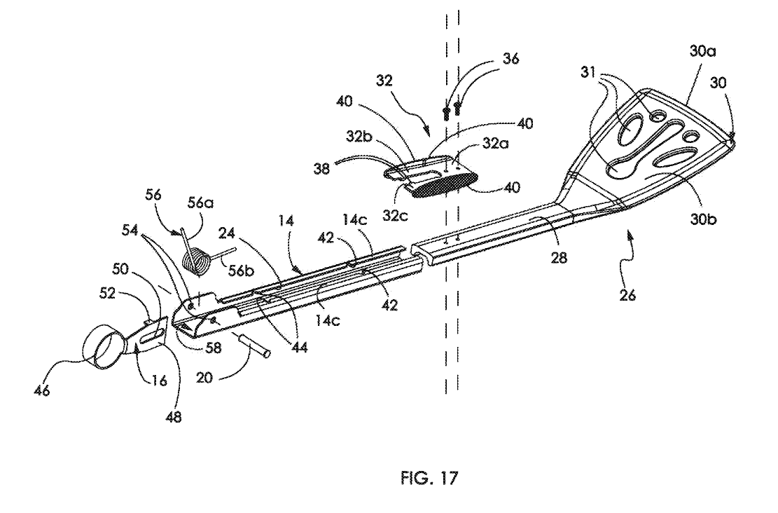

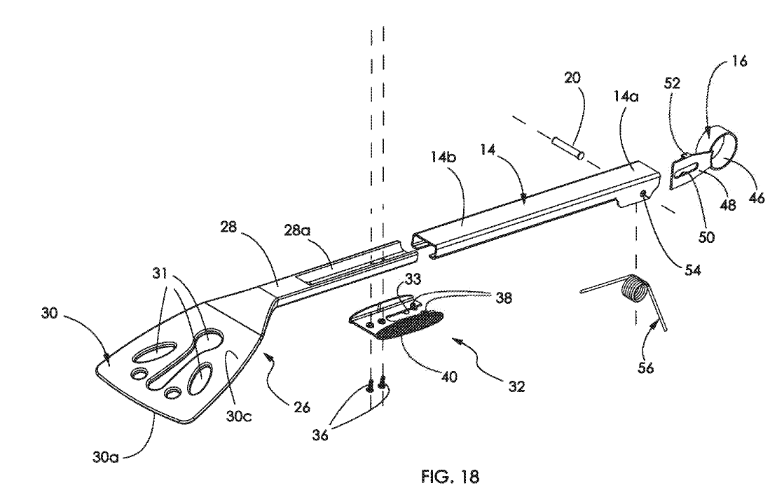

If the user requires a pair of tongs for turning a piece of meat over, for example, and flipper tong assembly 10 is in the extended position illustrated in FIG. 2, then the sides of locking member 32 are pushed inwardly to disengage detents 38 thereon from notches 43. Locking member 32 is then moved in the opposite direction to arrow “B” (FIG. 5). When detents 38 reach notches 44, locking member 32 locks assembly in the retracted position shown in FIG. 1. In this retracted position, tong member 22 and spatula member 30 are substantially adjacent and opposite each other, as may be seen in FIG. 7. Additionally, the handles of first and second arms 12, 14 are disposed substantially adjacent to each other and are locked in this closed orientation. The user may grasp ring member 46 of spring assembly 16 and push the same inwardly in the direction of arrow “F” (FIG. 1). This motion slides the flange 48 on spring assembly 16 in the direction of arrow “F” and spring 56 (FIG. 17) returns to its uncompressed state. The return of spring 56 to the uncompressed state causes first and second arms 12, 14 to pivot about rod 20 to the position where the arms 12, 14 are angled relative to each other (FIGS. 3 and 9). The user is then able to grasp first and second arms and manipulate them to capture objects between them, such as a piece of meat. Because of the positioning of spring assembly 16, second ends 12a and 14a may be pushed inwardly toward each other or be allowed to separate from each other in a similar manner to traditional tongs. The fact that the tips of digit regions 22c of tong member 22 are spaced a short distance inwardly from edge 30a of spatula member 30 also gives an improved gripping ability to flipper tong assembly 10 relative to traditionally known tongs.

Flipper tong assembly 10 is thus able to be used in the same manner as a traditional set of tongs when tong member 22 and spatula member are positioned substantially opposite each other. Flipper tong assembly 10 is further able to be used in the same manner as a traditional spatula when spatula member 30 is moved to the extended position. Because of the complementary angle of tong member 22 and spatula member 30 relative to the handles of first and second arms 12, 14, flipper tong assembly 10 is ideally suited for use in a confined environment such as a frying pan but is also suitable for use in other situations such as on a barbeque grill.

There is therefore disclosed a method of using a flipper tong assembly 10 comprising providing a utensil 10 having a first arm 12 with first and second ends 12a, 12b; a second arm 14 with first and second ends 14a, 14b; where the first ends 12a, 14a are pivotally engaged so that the first and second arms 12, 14 are selectively movable between a first position (FIG. 1) and a second position (FIG. 3). When in the first position, the handles of the arms 12, 14 are adjacent each other. In the second position the arms 12, 14, are located at an angle relative to each other. In assembly 10 the second end 22 of the first arm 12 is of a first configuration and the second end 30 of the second arm 14 is of a second configuration. The method further includes selecting the length of the second arm 14 to use the utensil as tongs or selecting the length of the second arm 14 to use the utensil as a spatula. When the length of second arm 14 is selected to use assembly 10 as tongues the method includes positioning the second ends 22, 30 substantially opposite each other. When the length of second arm 14 is selected to use assembly 10 as a spatula the method includes positioning the second end 30 of the second arm 14 a distance outwardly beyond the second end 22 of the first arm 12.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. A kitchen utensil comprising:
a first arm having a first end and a second end;
a second arm having a first end and a second end; wherein the first ends of the first and second arms are pivotably engaged with each other and the second ends are selectively movable laterally toward each other or away from each other; and
wherein the first arm is of a fixed first length measured between the first and second ends thereof and the second arm is of a variable second length measured between the first and second ends thereof.

2. The kitchen utensil as defined in claim 1, wherein the second arm is selectively movable between a retracted position and an extended position; and when the second arm is in the retracted position, the second ends of the first and second arms are generally laterally aligned with each other; and when the second arm is in the extended position, the second ends of the first and second arms are not laterally aligned with each other.

3. The kitchen utensil as defined in claim 2, wherein when the second arm is in the extended position the second end of the second arm is positioned a greater distance from the engaged first ends than is the second end of the first arm.

4. The kitchen utensil as defined in claim 2, further comprising a locking mechanism provided on the second arm; and wherein the locking mechanism is movable between an engaged and a disengaged condition; and when the locking member is engaged the length of the second arm is fixed, and when the locking member is disengaged the length of the second arm is variable.

5. The kitchen utensil as defined in claim 2, further comprising a locking mechanism provided on the second arm; and wherein the locking mechanism is selectively engaged to lock the second arm in each of the extended and retracted positions; and the locking mechanism is selectively disengaged to permit the second arm to be moved between the extended and retracted positions.

6. The kitchen utensil as defined in claim 1, wherein the second end of the first arm includes a first shaped food-contacting region and the second end of the second arm includes a second shaped food-contacting region; and wherein the first and second shaped food-contacting regions are dissimilar in configuration.

7. The kitchen utensil as defined in claim 1, wherein the second end of the first arm is shaped generally like a human hand.

8. The kitchen utensil as defined in claim 1, wherein the second end of the second arm is shaped like a food contacting region of a spatula or egg flipper.

9. The kitchen utensil as defined in claim 1, wherein each of the first arm and the second arm is comprised of a handle and a food-contacting region which extends outwardly from one end of the handle; and wherein the first ends of the first and second arms are located on the handles thereof; and the second ends of the first and second arms are the food-contacting regions thereof.

10. The kitchen utensil as defined in claim 9, wherein each of the first and second arms has a longitudinal axis which extends along the handle thereof; and the food-contacting region of each of the first and second arms is oriented at an angle relative to the longitudinal axis of the associated first or second arm.

11. The kitchen utensil as defined in claim 10, wherein the food-contacting regions of the first and second arms angle inwardly toward each other.

12. The kitchen utensil as defined in claim 1, wherein the second arm includes:
a handle defining a channel therein, where the channel is accessible through an opening defined at one end of the handle; and
a food-contacting region comprising a spatula with a leg extending outwardly from one end of the spatula; and wherein the leg is receivable through the opening and into the channel of the handle.

13. The kitchen utensil as defined in claim 12, wherein the leg is slidable within the channel between a first position and a second position; and when the leg is in the first position within the channel the second arm is of a first length; and when the leg is in the second position within the channel the second arm is of a second length.

14. A kitchen utensil comprising:
a first arm having a first end and a second end;
a second arm having a first end and a second end and a longitudinal axis extending therebetween; wherein the first ends of the arms are pivotally engaged with each other and the arms are movable between a first position where the second ends thereof are located laterally proximate each other and a second position where the second ends are located laterally spaced from each other; and
wherein the second arm is a telescoping arm and the second end thereof is selectively extendable along the longitudinal axis thereof.

15. The kitchen utensil of claim 14, wherein the second arm is movable between a retracted position and an extended position; and when the second arm is in the retracted position the second end of the second arm is generally aligned with the second end of the first arm; and when the second arm is in the extended position, the second end of the second arm is not aligned with the second end of the first arm and is positioned a distance outwardly beyond the second end of the first arm.

16. The kitchen utensil as defined in claim 15, wherein the second arm defines a channel therein and the second arm includes an extension that is movable within the channel to move the second arm between the retracted and extended positions.

17. The kitchen utensil as defined in claim 16, wherein the extension includes a leg having one end that is insertable into the channel and a spatula member engaged with an opposite end of the leg.

18. The kitchen utensil as defined in claim 17, wherein the second end of the first arm includes a tong member.

19. The kitchen utensil as defined in claim 18, wherein the tong member is from about 20% up to about 35% smaller than the spatula member.

20. A method of using a kitchen utensil comprising:
providing a utensil having a first arm with first and second ends and a second arm with first and second ends, and where the first arm is of a fixed length and the second arm telescopes and is of a variable length; where the first ends of the arms are pivotally engaged so that the arms are selectively movable between a first position where they are adjacent each other along their lengths and a second position where the arms are disposed at an angle relative to each other; and where the second end of the first arm is of a first configuration and the second end of the second arm is of a different second configuration;
selecting the length of the second arm so that the second ends of the arms are substantially opposite and laterally adjacent each other to use the utensil as tongs; or
selecting the length of the second arm so that the second end of the second arm is located a distance outwardly beyond the second end of the first arm to use the utensil as a spatula.
